(19) United States
(12) Patent Application Publication
(10) Pub. No.: US 2015/0037121 A1
(43) Pub. Date: Feb. 5, 2015

(54) System For Using an Exchangeable Glue Cartridge, And A Bookbinding Machine

(71) Applicant: Maping Kommandiittiyhtiö L. Huotari, Espoo (FI)

(72) Inventor: Iisakki Huotari, Espoo (FI)

(21) Appl. No.: 14/446,861

(22) Filed: Jul. 30, 2014

(30) Foreign Application Priority Data
Aug. 2, 2013 (EP) 13179170.9

(51) Int. Cl. B42C 9/00

(52) U.S. Cl. CPC B42C 9/0006
USPC 412/37

(57) ABSTRACT

An exchangeable glue cartridge to be used in a bookbinding machine comprises a retaining arrangement which forms a self-adjusting or adjustable jaw wherein the platform of the glue cartridge can be pushed in such a way that the glue spreading roller is downward or remains downward. The jaw limits the vertical mobility of the glue cartridge in both directions by limiting the mobility of the platform. In addition, the system comprises at least one rotatable converter for transmitting the motion to at least one rotating device located in the glue cartridge while the glue cartridge is mounted in place. By means of the self-adjusting or adjustable jaw it is possible to increase the manufacturing tolerances of the glue cartridge and to prevent the glue cartridge from getting blocked in the system.

### TECHNICAL FIELD

The invention is related to the field of bookbinding.

### BACKGROUND INFORMATION

The demand for hot-melt adhesive binding machines or perfect binding machines has increased strongly in recent times. This is partly due to the rapid development of digital printing technology. Using this type of machines it is possible to produce books in small series and even single copies of books in an economically sensible way. The operating principle of the popular perfect binding machine offered by the applicant has been described in international patent application published as printed document WO 03/064169 A1.

A photo book can be mentioned as an example of books produced in small series or in single copies. Along with the breakthrough of digital camera and image processing technology, the demand for photo books has increased greatly.

When state-of-the-art digital printing technology, with the paper passing through many rollers and cylinders, is used for printing, the best end product is nowadays obtained by printing on coated and/or strongly glazed paper grades. The print quality is then brilliant at best, and it is possible to achieve a color rendering of images that is very close to the desired color rendering.

Experience shows that the best result in bookbinding using the perfect binding method is achieved when the book is made of uncoated and unglazed paper. However, it is not possible to print on this kind of paper by means of the state-of-the-art digital printing technology in such a way that the end product would be comparable to printing carried out on coated and/or strongly glazed paper grade.

Perfect binding for small series is nowadays most commonly carried out by means of EVA hotmelt (EVA=ethylene-vinyl-acetate-copolymer). The processing temperature of EVA hotmelt is approx. 170° C., and the adhesive must be applied to the spine of the book to be bound during a so-called open time, which is approx. 10 to 60 seconds, during which the adhesive is not yet cured and is still processible. The EVA hotmelt within the bookbinding machine will melt again when heated.

Industrial bookbinding is nowadays increasingly carried out by means of PUR adhesive (more accurately: polyurethane hot-melt adhesive). The processing temperature of PUR adhesive is approx. 130° C. The PUR adhesive already cures during cooling but, for the final curing, the PUR adhesive absorbs additionally moisture from the air. The adhesive undergoes then transition into insoluble urea. This kind of cured PUR adhesive cannot be remelted when heated.

Binding by means of EVA hotmelt is not as heat-resistant as binding by means of PUR adhesive. The PUR adhesive enables to achieve a better bonding strength than the EVA hotmelt for certain paper grades. However, the use of PUR adhesive is more complicated than the use of EVA hotmelt because bookbinding machines using PUR adhesive require intensive cleaning to be able to continue using the machines.

As regards the above-mentioned paper grades and the quality aspects of printing, both EVA hotmelt and PUR adhesive have their advantages. However, as things are developing, the result may be that future bookbinding machines are expected to allow the use of both EVA hotmelt and PUR adhesive. A solution to this demand, anticipated by the applicant, is presented in a patent application published on 7 Aug. 2013 as printed document EP 2 623 212, viz. an exchangeable glue cartridge making the use of a bookbinding machine easier.

An exchangeable glue cartridge presents many advantages compared for example with the “EZ-Clean Tank” arrangement of Horizon International, Inc., referred to in the patent application mentioned here.

### SUMMARY OF THE INVENTION

The purpose of the invention described in the present application is to facilitate the use of a perfect binding machine by improving the availability of exchangeable glue cartridges.

The system for using an exchangeable glue cartridge according to the present invention is meant to be used in combination with a glue cartridge comprising i) a glue tank as well as a platform connected to it, ii) a rotatable glue spreading roller connected to the glue tank, arranged directly below the glue tank and designed in such a way that the shape of the glue spreading roller prevents glue from escaping from the glue tank when the glue spreading roller is in place, on the one hand, and taking glue from the glue tank when the glue spreading roller is being rotated, on the other hand, as well as iii) at least one rotating device, available outside the glue tank, for rotating the glue spreading roller.

The system for using an exchangeable glue cartridge comprises at least one retaining arrangement forming a self-adjusting or adjustable jaw into which the platform of glue cartridge may be pushed in such a way that the glue spreading roller is pointing downward or remains downward and which is configured to limit the vertical mobility of the glue cartridge in both directions by limiting the mobility of the platform. In addition, the system comprises at least one rotatable converter for transmitting the motion to at least one rotating device in the glue cartridge while the glue cartridge is mounted in place.

The inventor has discovered that exchanging the glue cartridge described in the printed document EP 2 623 212 becomes easier if the system is used, thanks to the self-adjusting or adjustable jaw.

By using the system, it is thus possible to allow for a greater tolerance variation of the glue cartridge platform dimensioning. Even if the glue cartridge platform were somewhat thicker or thinner, the self-adjusting or adjustable jaw enables to mount the glue cartridge in the system and, on the other hand, to hold it firmly in place.

By using the system, it is thus also possible to prevent problems caused by a possibly different thermal expansion or different stages of thermal expansion between the system and the glue cartridge. When the system is cold (e.g. at room temperature), it is possible to mount a hot glue cartridge (e.g. one which is at operating temperature) therein, or a cold glue cartridge (e.g. one which is at room temperature) can be mounted in a hot system (e.g. one which is at operating temperature).

According to an advantageous aspect, the jaw can comprise at least one shoulder as a shape-limited upper limit for the glue cartridge in vertical direction. In addition to this, or as an alternative to this, the jaw can comprise at least one resilient or resiliently mounted lower part. If the jaw comprises at least one shoulder, as described above, the resilient or resiliently mounted lower part is most advantageously movable toward the shoulder and/or away from it. The resilient or resiliently mounted lower part is an effective way of implementing the self-adjusting jaw because the resilience enables to position the glue cartridge in the system very accurately to a large degree irrespective of any possible manufacturing tolerances and varying thermal expansion of the different parts of the system, as well as of any differences in temperature between the system parts (and glue cartridge) during mounting.

According to an advantageous aspect, the lower part can be a heater or it can contain a heater. In this case, at least one heater is most advantageously arranged in such a way that it heats the platform of the glue cartridge from below. The inventor has discovered that this increases the operating reliability of the glue cartridge. Particularly advantageously, the heaters form a pair arranged in such a way that it heats the platform of the glue cartridge from both sides of the glue spreading roller. In this way, heat is conducted from the platform into the glue spreading roller, which ensures that glue at the glue spreading roller can be better kept at processing temperature. The arrangement also speeds up the warming-up of glue cartridge.

According to an advantageous aspect, the retaining arrangement can comprise at least one pair of supporting elements or arms between which the glue cartridge can be mounted. In this case, the jaw is implemented by means of the supporting elements or arms. The projection or lower part is (or both are) thus most advantageously a part of the supporting elements or arms.

According to an advantageous aspect, the mutual dimensioning of the platform and supporting elements or arms can be implemented in such a way that at least one narrowed part remains on one side or on both sides between the platform and the supporting elements or arms, whereby a gap remains between them at the narrowed part (or narrowed parts). The narrowed part (or narrowed parts), which can be implemented e.g. by removing material from the guide surfaces of the glue cartridge so that only the necessary small guide surfaces remain, can be used to reduce the contact surface between the glue cartridge and the supporting elements or arms so that an air gap remains between the glue cartridge and the supporting elements or arms. This helps to better avoid the conduction of dissipated heat into the supporting elements or arms.

According to an advantageous aspect, the system can comprise a spring system for pressing or pushing the glue cartridge toward the second retaining arrangement in horizontal direction. In this way, the correct mutual orientation of the converter in the system and the at least one rotating device in the glue cartridge can be ensured better: When the distance from the converter (e.g. from torque converter) to the retaining arrangement (e.g. arms) is adequate, the glue cartridge is pressed against the second retaining arrangement while the shaft of the glue spreading roller is aligned with the axle line of the converter. With the distance from the converter to the surface of the shoulder of the opposite retaining arrangement (e.g. arm) being greater than that from the glue spreading roller to the edge of the left-hand shoulder of the glue cartridge, a gap remains between the glue cartridge and said opposite retaining arrangement.

According to an advantageous aspect, the system can additionally comprise a half-open side heater, a half-open surface heater and/or a half-open jacket heater which uses the heat to be conducted through the side walls, surface and/or jacket surface of the glue tank for heating the glue in the glue tank of the glue cartridge mounted in place. Thanks to the half-open heaters, the glue cartridge can be simply pushed into its place in the system. This makes it easier to mount the glue cartridge in the system compared with the solution described in printed document EP 2 623 212 according to which the heater is placed separately around the glue tank.

The side, surface and/or jacket heater is best positioned against the glue tank while the glue cartridge is mounted in place. The jacket surface of the jacket heater is most advantageously in the shape of a cylindrical segment. This enables to arrange the necessary heating for the glue cartridge with the minimum possible heat dissipation.

If the side, surface and/or jacket heater is resiliently mounted, e.g. by means of compression springs, this enables to press the heater tightly against the glue tank. Thanks to the resilient mounting of the heater, the system can be implemented within simply achievable manufacturing tolerances.

According to an advantageous aspect, the system can also comprise a releasable locking mechanism for preventing the removal of the glue cartridge mounted in place. By means of the closed locking mechanism it is possible to prevent removal of the glue cartridge from the receiving unit by mistake.

By means of the system, which additionally comprises a glue cartridge mounted in place, wherein a converter available outside the glue cartridge is arranged to rotate the rotating device of the glue cartridge, whereby the glue spreading roller can be rotated by means of the converter, it is possible to better avoid any damages possibly caused by the use of an incorrectly mounted glue cartridge, because the converter must be connected to the rotating device of glue cartridge so that the glue spreading roller would rotate. Depending on the implementation, a prerequisite for the rotation of the glue spreading roller is that the glue cartridge is perfectly or at least almost at the correct position.

According to an advantageous aspect, the system can also contain a fixed or a detachable setting device for removing the glue cartridge from the system or for mounting it in the system. This makes it easier to mount the hot glue cartridge in the system, to mount the glue cartridge in the hot system, as well as to remove the glue cartridge from the hot system.

A bundle of sheets to be bound to make a book can be set into the bookbinding machine. Adhesive can be applied to the spine of the bundle by means of the bookbinding machine in such a way that the adhesive can be taken from a glue cartridge by using the system. In this way, it is possible to utilize the machine geometry known from the Fastbind Elite-type perfect binding machine also in a perfect binding machine using a glue cartridge. Thanks to the self-adjusting or adjustable jaw of the system, the mounting of glue cartridges is easier even if the glue cartridges have a different temperature than the system. It is also possible to reduce the operating costs of the bookbinding machine as the tolerance requirements of the glue cartridges can be widened thanks to the system.

Advantageously, the bookbinding machine comprises a backwards and forwards movable glue spreading unit, configured to rotate the glue spreading roller or an exchangeable glue cartridge while the glue spreading unit is moved backwards and forwards, whereby the glue contained in the glue tank can be applied to the spine of the bundle of sheets.

### BRIEF DESCRIPTION OF THE DRAWINGS

These and other features and advantages of the present invention will be better understood by reading the following detailed description, taken together with the drawings wherein:

FIG. 1 shows the glue cartridge and the cover of a glue cartridge;

FIG. 2 shows an exploded view of the glue cartridge presented in FIG. 1;

FIG. 3 shows a rear view of the glue cartridge presented in FIG. 1;

FIG. 4 shows a side view of the glue cartridge presented in FIG. 1 from the right;

FIG. 5 shows a bottom view of the glue cartridge presented in FIG. 1;

FIG. 6 shows a top view of the glue cartridge presented in FIG. 1;

FIG. 7 shows a glue cartridge equipped with a cover to which a mounting plate is being attached for fixing a setting device;

FIG. 8 shows a system for using the exchangeable glue cartridge with a glue cartridge being mounted therein by means of the setting device;

FIG. 9 shows a system wherein the glue cartridge is mounted in place, with an open locking latch;

FIG. 10 shows a side view of the system presented in FIG. 9 from the left;

FIG. 11 shows the system presented in FIG. 9 after removing the setting device, with a closed locking latch;

FIG. 12 shows a side view of the system presented in FIG. 11 from the left;

FIG. 13 shows the heater implemented as lower part;

FIG. 14 shows an exploded view of the glue cartridge receiving unit, illustrating the mounting of the heaters presented in FIG. 13;

FIG. 15 shows an exploded view of the glue cartridge receiving unit, illustrating the mounting of the heater for the glue cartridge;

FIG. 16 shows an exploded view of the glue cartridge heater presented in FIG. 15;

FIG. 17 shows a detail of the glue cartridge receiving unit, illustrating the lateral spring system;

FIG. 18 shows an exploded view, illustrating the mounting of the lateral spring system presented in FIG. 17;

FIG. 19 shows the bookbinding machine;

FIGS. 20 and 21 show cross sections of the glue spreading roller casing;

FIG. 22 shows a bottom view of the glue spreading roller casing;

FIG. 23 shows a top view of the glue spreading roller casing; and

FIG. 24 shows a longitudinal section of the glue spreading roller casing.

The same reference numbers refer to same technical features in all drawings.

### DETAILED DESCRIPTION OF THE PREFERRED EMBODIMENTS

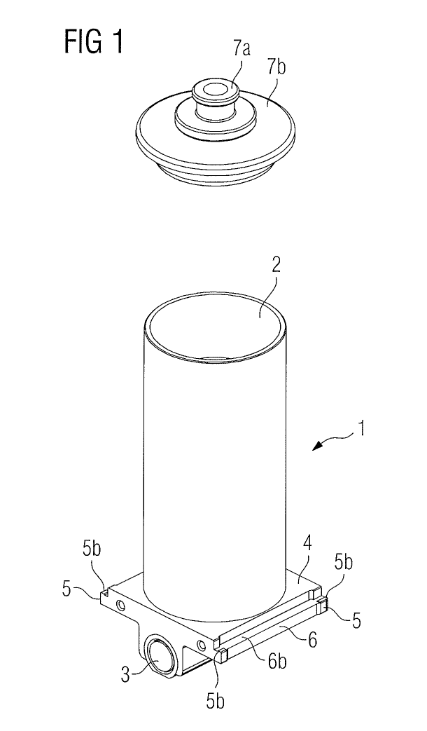

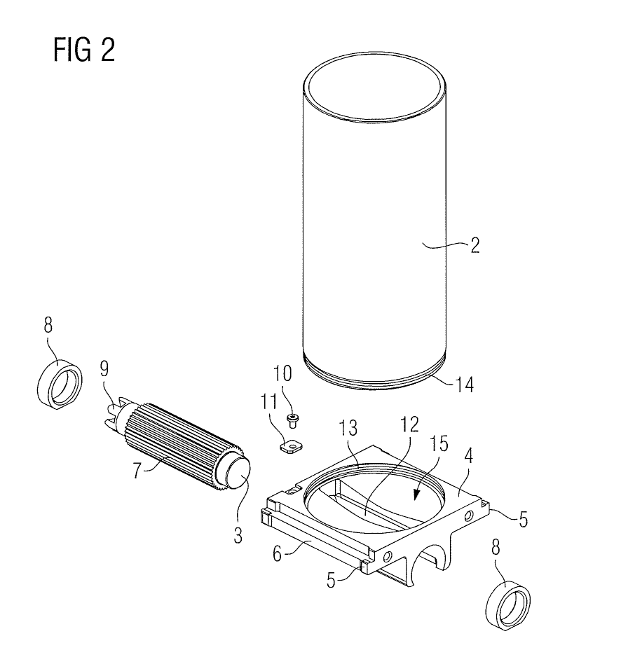

FIG. 1 shows glue cartridge 1 and cover of the glue cartridge 7b. FIG. 2 shows an exploded view of glue cartridge 1.

Glue cartridge 1 comprises glue tank 2. Glue tank 2 may contain either PUR adhesive or EVA hotmelt (either one of them or both are referred to more generally by the term glue in the following). Glue cartridge 1 is either closed from the top or can be closed from the top. In other words, cover 7b can be either a fixed or a detachable part of glue cartridge 1. If cover 7b is detachable, it can be equipped with knob 7b to facilitate detaching.

In addition, glue cartridge 1 comprises glue spreading roller 7. Glue spreading roller 7 is a part of shaft 3 which most advantageously has shaft surfaces for bearing support. The bearing support is implemented by means of bearings 8. Material may have been removed from the surface of bearings 8 (e.g. by surface milling on the lower surface). This is utilized if the glue cartridge is being purged at the cleaning station. Slide bearings or cylinder liners are most advantageously used as bearings 8.

The surface of glue spreading roller 7 is toothed e.g. by means of grooving and/or by making other appropriate surface reliefs into it, for instance protrusions, or combinations of these. Bearings 8 are mounted tightly against the shaft surfaces of shaft 3 thus acting as seals. The wall thickness of bearings 8 is greater than the depth of the area between the adjacent teeth or projections of glue spreading roller 7. Bearings 8 are set tightly against the ends of glue spreading roller 7 (i.e. the toothed part of shaft 3) on either side.

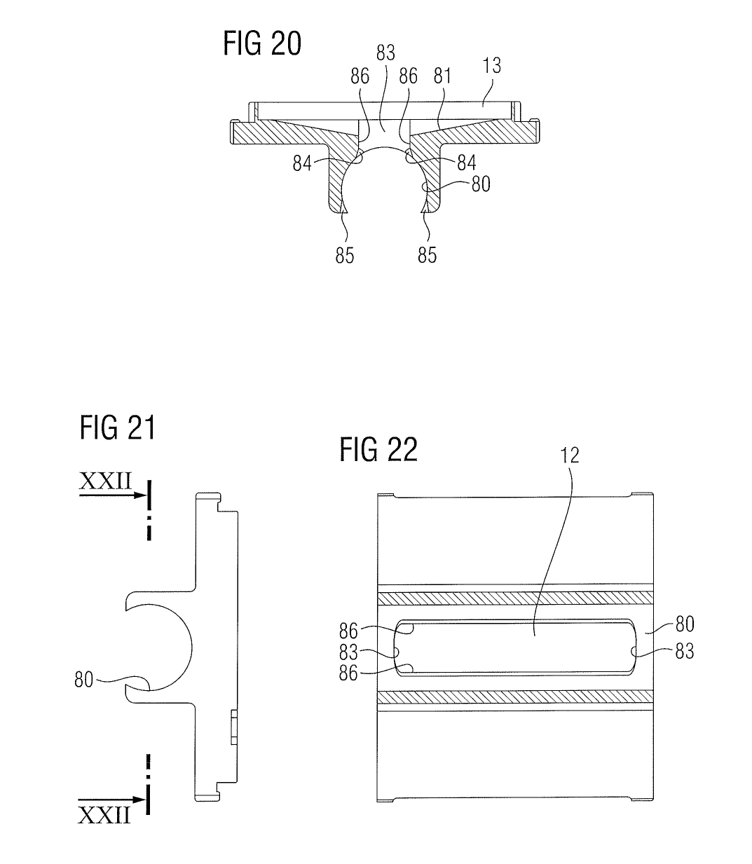

The outside diameter of bearings 8, the outside diameter of glue spreading roller 7 and the inner surface of glue spreading roller casing 80 (ref. FIG. 20) have approximately the same diameter so that the resulting structure is so tight that glue cannot escape from glue tank 2 by mistake.

However, the dimensioning allows glue spreading roller 7 to be rotated at the processing temperature of glue.

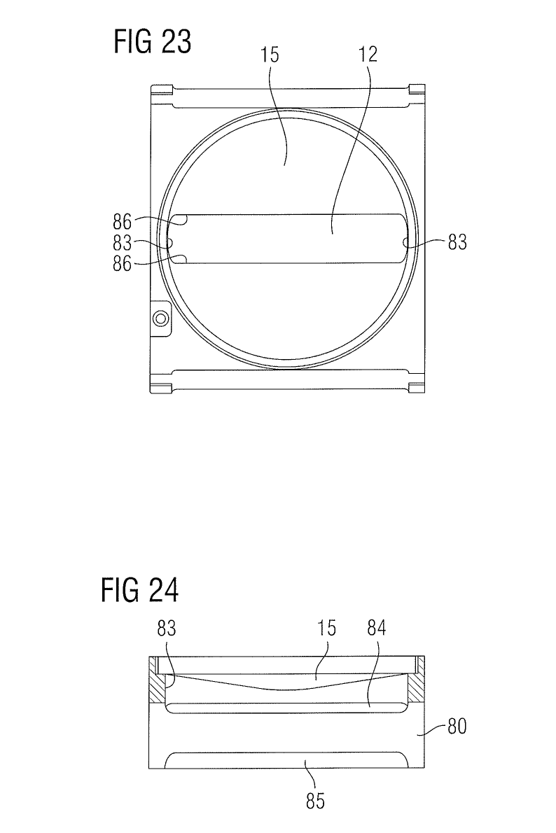

The advantageous structure of glue spreading roller casing 80 is more evident from the drawings presented in FIGS. 20 to 24.

Rotating device 9 is most advantageously implemented as protrusions in the other end of shaft 3 which enable the rotating of glue spreading roller 7 by means of shape-limiting transmission mechanism, together with the recesses remaining between the protrusions of torque converter 32.

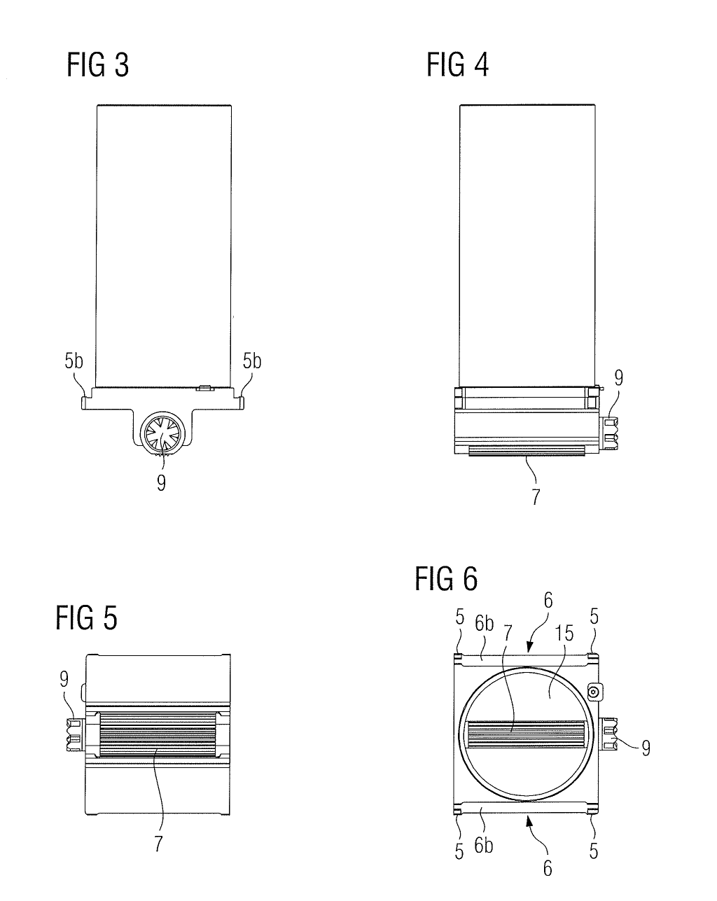

FIGS. 2 to 6 show details of platform 4 of glue cartridge 1, glue channel 12, and tank bottom 15. Platform 4 of glue cartridge 1 and glue tank 2 can be implemented in one piece or made of two or several separate parts. Platform 4 and glue tank 2 can be connected to each other for example by means of threads 13, 14.

Identification element 11 is attached to glue cartridge 1, 20, for example with screw 10. Bookbinding machine 100 identifies the type of glue cartridge on the basis of identification element 11 and sets the target temperature of the heater of glue cartridge 1, 20 and/or the power of the heater according to the type of the glue cartridge.

Both edges of glue cartridge 1 are provided with extension 5. There is a narrowed part 6 in the middle of extensions 5. Extension 5 at the narrowed part 6, i.e. in the middle, does not reach as far as it does at the ends. The narrowed part of upper part 6b is for example implemented by narrowing extension 5 on the top. Thanks to the narrowing of upper part 6b it is possible to implement stop face 5b with a small surface only. This reduces the conduction of heat from glue cartridge 1 into glue cartridge receiving unit 26.

Even if there is a narrowed part in the middle of extensions 5 in our exemplary embodiment, lateral narrowing 6 is only necessary on the side where the platform is supported by the arm. On the side of springs 64, an air gap remains between shoulder 42 in arm 41a and platform 4 in any case. If narrowing 6 is made into platform 4 also on the side of springs 64, it may have a negative effect if the fact is not taken into account that extension 5 momentarily presses spring 64 deeper during mounting than its position would be when the cartridge is mounted in place (i.e. to the bottom of narrowed part 6). This means that glue cartridge 1, 20 can also be implemented provided with unilateral narrowing 6 or without any narrowed parts because the effect caused by the narrowing can also be achieved by choosing an appropriate shape of jaw.

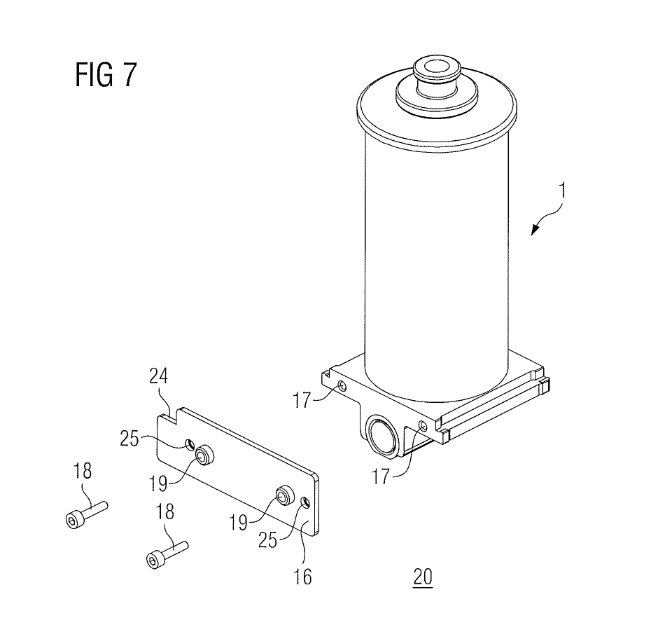

FIG. 7 shows glue cartridge 1 equipped with a cover with mounting plate 16 being attached to it. To be able to lock glue cartridge 1 in place in the system by means of the locking latch, mounting plate 16 is mounted on glue cartridge 1 by means of fixing screws 18. The face of glue cartridge 1 is provided with threaded holes 17 for this purpose.

Mounting plate 16 of glue cartridge 1 has raising bushes 19 for forming an air gap between the plate part of mounting plate 16 of glue cartridge 1 and the face of glue cartridge 1. The hole in raising bush 19 is used as an inlet for fixing screws 18 of the glue cartridge. This results in a small contact surface between the (hot) glue cartridge 1 and mounting plate 16 and in a reduced transfer of dissipated heat to mounting plate 16. Mounting plate 16 has also holes for compression nuts 25. Fixing screws 23 of setting device 21 are fixed to compression nuts 25.

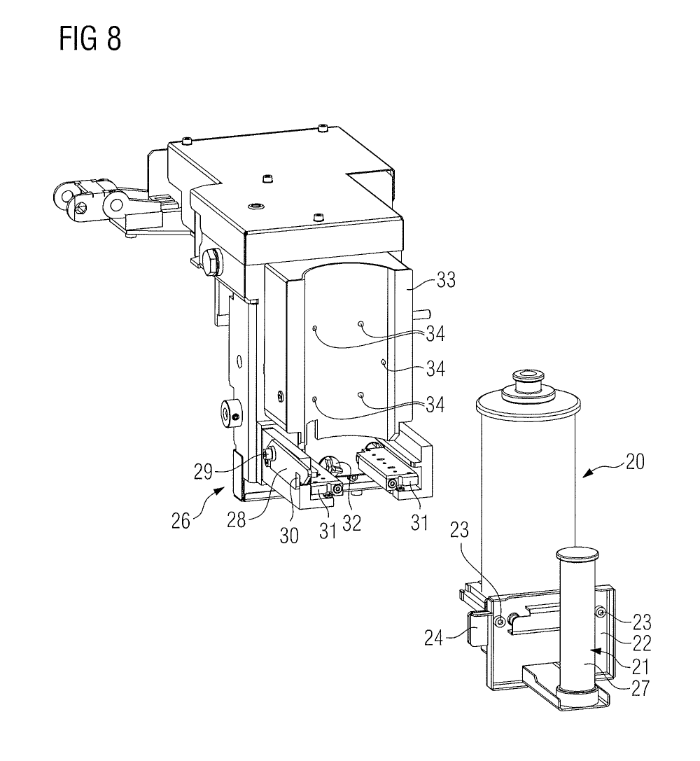

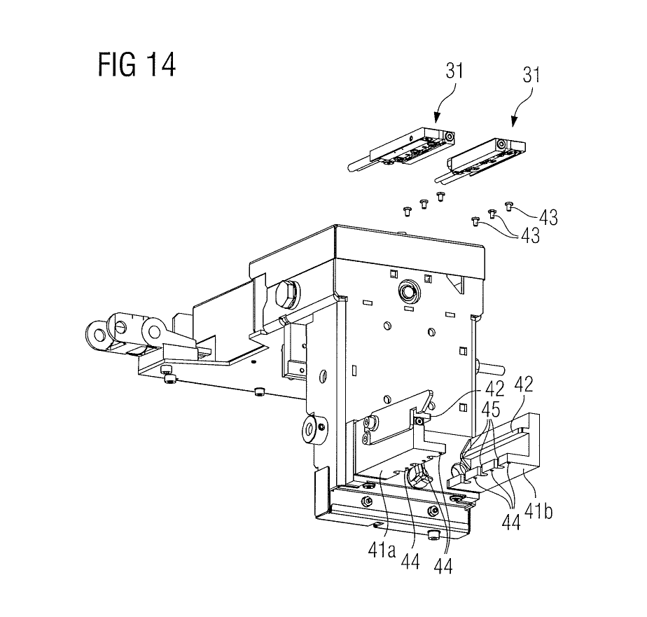

As shown in FIGS. 8 and 14, glue cartridge receiving unit 26 comprises two arms 41a, 41b. Moreover, glue cartridge receiving unit 26 comprises shoulder 42 in both arms. Shoulder 42 and the spacing between arms 41a, 41b, as well as lower heaters 31 form the jaw. The width and height of platform 4 are dimensioned in such a way that glue cartridge 20 equipped with a fixing plate can be pushed into the jaw of receiving unit 26 by means of setting device 21 so that extensions 5 of platform 4 are positioned between lower heaters 31 and shoulders 42 on both sides. In this way, the jaw holds glue cartridge 1 in place in receiving unit 26 and prevents glue cartridge 1 from falling down.

When setting device 21 is fixed to glue cartridge 20 equipped with mounting plate 16 by means of its fixing screws 23, the cover trough in setting device 21 covers the heads of fixing screws 18 of mounting plate 16 of glue cartridge 20. In this way, any accidental opening of fixing screws 18 of mounting plate 16 of glue cartridge 20 is prevented when fixing screws 23 of setting device 21 are meant to be opened in order to remove setting device 23.

If required, setting device 21 can be dimensioned in such a way that protective cover 115 or protective casing on bookbinding machine 100 cannot be closed while setting device 21 is attached. In other words, setting device 21 would in that case prevent the closing of protective cover 115 or protective casing.

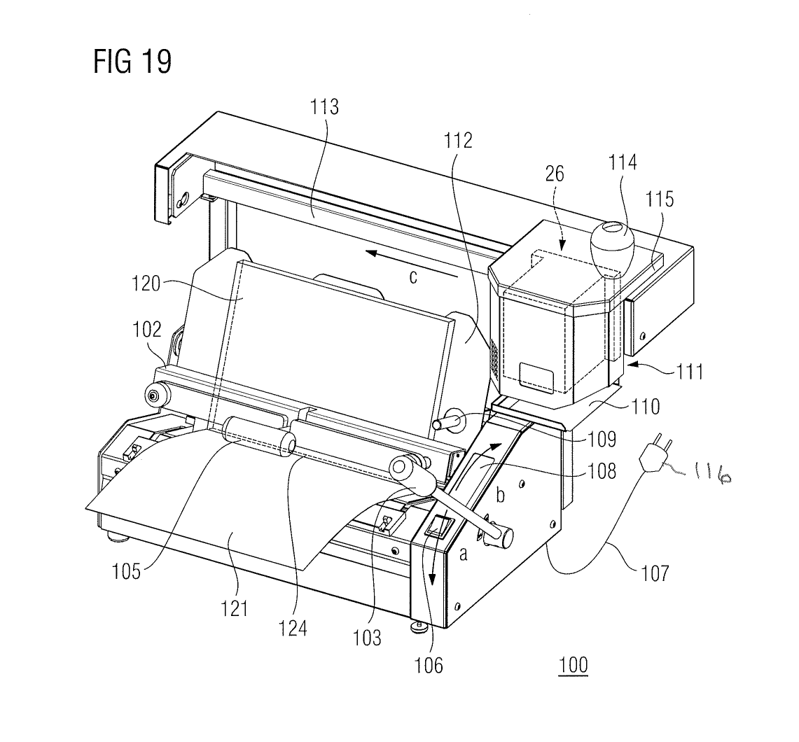

Glue cartridge receiving unit 26 is attached to bookbinding machine 100 (FIG. 19).

Arms 41a, 41b are attached to the back of receiving unit 26 by means of fasteners, such as screws, most advantageously through the inlets made into the back.

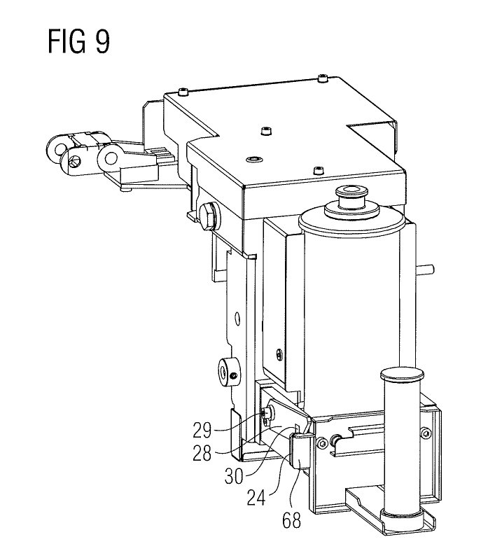

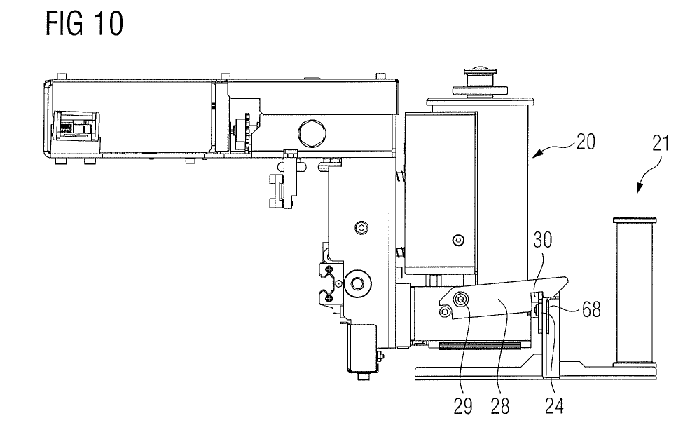

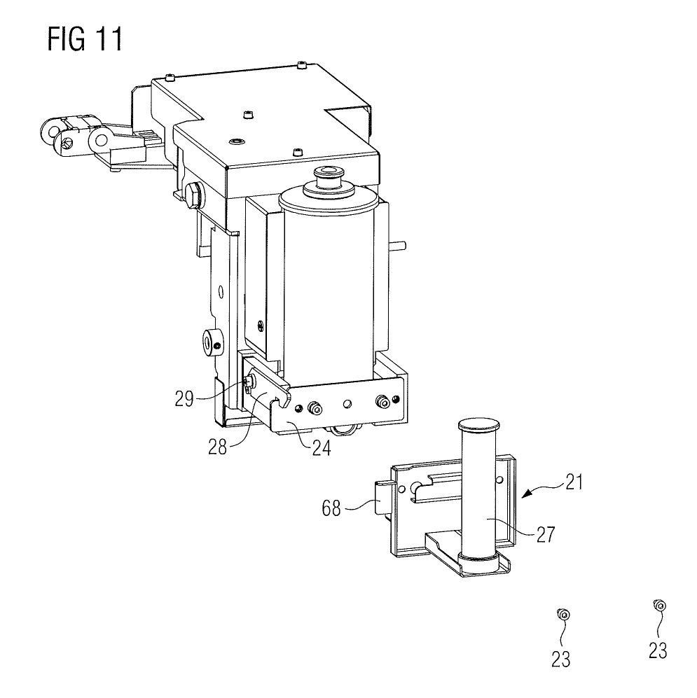

As shown in FIGS. 9 to 12, glue cartridge 1, 20 can be attached to glue cartridge receiving unit 26 by means of locking latch 28 which can be turned in relation to bearing journal 29. Locking groove 30 of the locking latch is positioned on mounting plate 24 and prevents any unintentional removal of glue cartridge 1, 20.

After mounting glue cartridge 1, 20 in place, setting device 21 can be removed. For this purpose, fixing screws 23 are loosened and setting device 21 is pulled out. Thanks to the remaining air gap between mounting plate 16 and setting device 21 (ref. raising bushes 19) it is possible to reduce the heating of fixing screws 23 and setting device 21. The removal of setting device 21 can be carried out safely by means of handle 27.

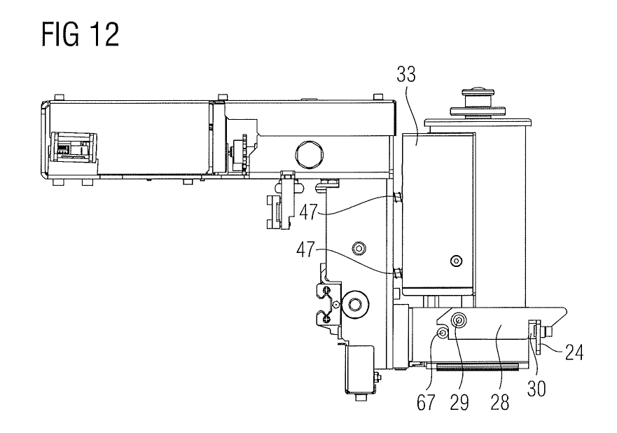

Locking latch 28 opens when setting device 21 is attached to glue cartridge 20 equipped with mounting plate 16 by means of fixing screws 23. Glue cartridge 1 can then be detached by pulling out handle 26 in setting device 21. When glue cartridge 20 equipped with mounting plate 16 is removed from receiving unit 26, locking latch 28 settles due to or assisted by gravity (by means of gravitational force) to its lower position against limit stop 67 (in the drawing shown in FIG. 12, limit stop 67 is the head of an Allen screw, and the Allen screw is screwed in the left arm 41a). The rear part of locking latch 28 is hinged, and a hinge bushing screwed on the left arm 41a is used as bearing journal 29.

Glue cartridge receiving unit 26 comprises converter 32 which has a traction element (most advantageously a gear or a sprocket, not shown in FIG. 8) and a formed part which are permanently attached to each other through the opening of the axle system in such a way that the traction element can be accessed from outside the receiving unit 26.

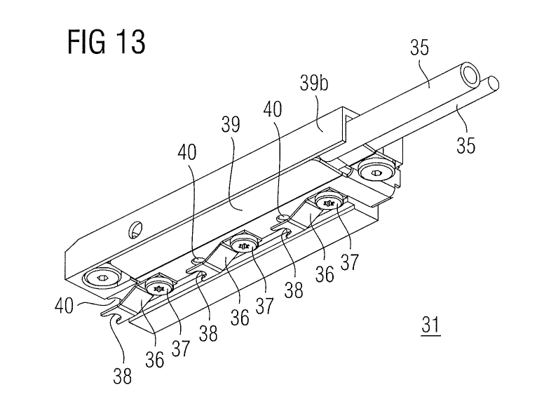

FIG. 13 illustrates the structure of lower heater 31 in more detail. Lower heater 31 has electric cables 35 underneath guard plate 39 of the switch room. One electric cable 35 is used for applying the voltage to the heating resistor installed inside the heater body and the excess heat protection connected in series to it. The other electric cable, for its part, is used for conducting electricity to the temperature sensor attached to the heater body.

Located below lower heater 31 are springs 36 which are attached to lower heater 31 by means of screws 37. Springs 36 are provided with loop 38 at the lower end. Lower heater 31 also has through holes 40 for the clamping tool.

Fixing screws 43 are initially fastened to mounting holes 44 (ref. FIG. 14). After that, loops 38 are pushed into fixing screws 43 and fixing screws 43 are tightened via through-hole 40 of the tool. If necessary, screws 37 can be tightened by means of the through holes 45 of the tool while lower heater 31 is mounted in place.

Glue cartridge receiving unit 26 is thus equipped with lower heaters 31, with springs 36 mounted below them for supporting lower heaters 31. Springs 36 also yield, in this way allowing for the downward and upward movement of lower heaters 31. Springs 36 are most advantageously dimensioned in such a way that they support lower heaters 31 at a level which allows for a gap which is smaller than or equal to the thickness of extension 5 of glue cartridge 1 to remain in arm 41a, 41b, between lower heater 31 and shoulder 42 of arm 41a, 41b.

The upper edge in front of lower heater 31 has been bevelled so that glue cartridge 1, 20 can be easily pushed into place. The front edge of shoulder 42 of arm 41a, 41b has also been beveled to ease the mounting of glue cartridge 1, 20. When glue cartridge 1, 20 has been mounted in place in the receiving unit, the top surfaces of lower heaters 31 are pressed against the bottom surface of glue cartridge 1, 20 by means of springs 36, and springs 36 lift extensions 5 of the glue cartridge toward the bottom surfaces of shoulders 42 of arms 41a, 41b of the top surface. To reduce the heat conduction, however, only stop faces 5b of the upper side make a contact with shoulders 42.

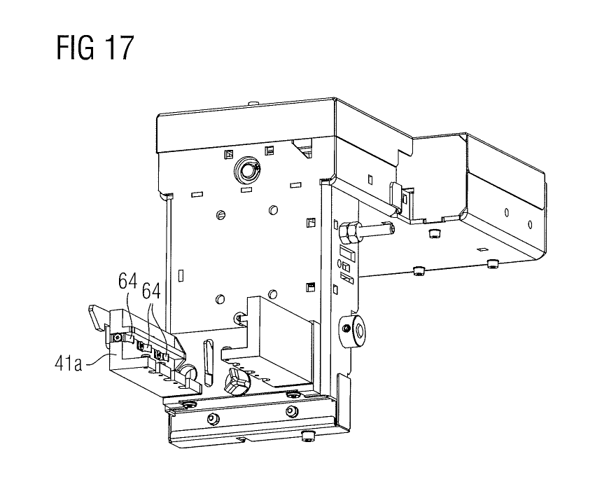

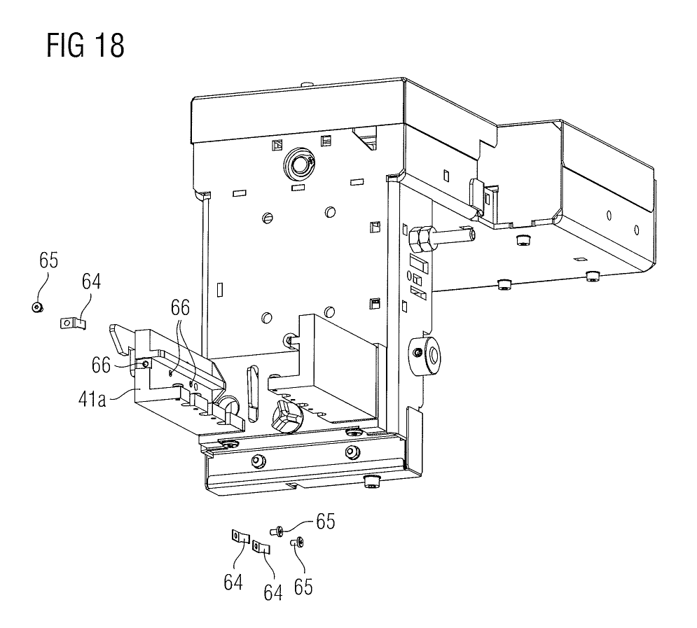

FIGS. 17 and 18 illustrate the implementation of the lateral spring system of glue cartridge receiving unit 26. The left arm 41a has springs 64. Springs 64 are fastened to mounting holes 66 by means of screws 65.

Springs 64 in the left arm 41a of glue cartridge receiving unit 26 yield when the glue cartridge is pushed into place in receiving unit 26. These springs 64 also press glue cartridge 1, 20 against the right arm 41b. One of the springs 46 is most advantageously mounted from the front and two are mounted from inside in the left arm 41a.

As described above, the jaw of glue cartridge receiving unit 26 is self-adjusting both vertically and horizontally. It is clear that the jaw must not necessarily be self-adjusting or adjustable both vertically and horizontally but, in principle, even one of the two may suffice.

In view of ensuring the heat conduction, the fact that the jaw is vertically self-adjusting or adjustable is important. Both a vertically self-adjusting jaw and a horizontally self-adjusting jaw have an effect on the mutual functioning of torque converter 32 and rotating device 9.

The easiest way of implementing a vertically self-adjusting jaw is by means of springs. As an alternative to the vertically self-adjusting jaw, the jaw can be implemented as a vertically adjustable jaw, for example by shifting (e.g. by turning at least one set screw) lower heaters 31 downward at first so that glue cartridge 1 can be pushed into place in the glue cartridge receiving unit and, after this, by shifting (e.g. by turning at least one set screw) lower heaters 31 upward so that lower heaters 31 are tightly against platform 4 of glue cartridge 1.

Likewise, the easiest way of implementing a horizontally self-adjusting jaw is by means of springs 64. As an alternative to the horizontally self-adjusting jaw, the jaw can be implemented as a horizontally adjustable jaw, for example by shifting the glue cartridge 1 laterally toward one of the arms 41a, 41b (e.g. by turning at least one set screw).

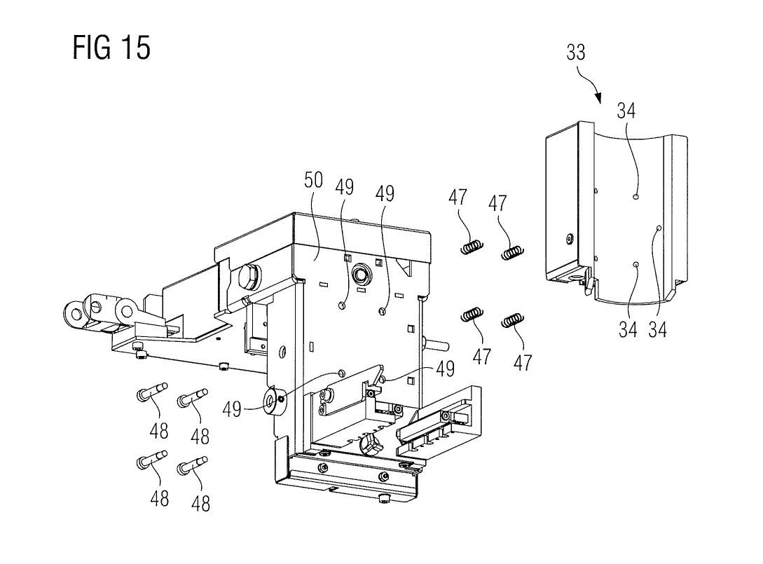

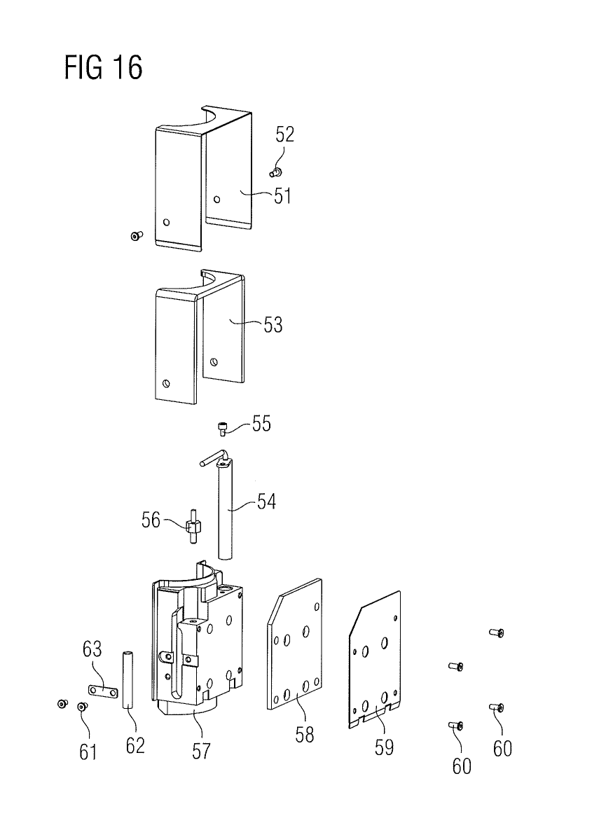

As shown in FIGS. 8 and 12, glue cartridge receiving unit 26 is equipped with side heater 33. Side heater 33 is preferably spring-loaded (ref. FIGS. 12 and 15). An exploded view of side heater 33 is shown in FIG. 16.

Side heater 33 is preferably implemented as a half-open jacket heater. This enables to push the glue cartridge into place. FIGS. 12 and 15 illustrate the implementation of glue cartridge receiving unit 26 with regard to the attachment of side heater 33. FIG. 16 illustrates the design of side heater 33.

Side heater 33 is resiliently mounted on rear part 50. Side heater 33 has mounting holes 34 and rear part 50 has mounting holes 49 for this purpose. The springs are pressed between side heater 33 and rear part 50 by means of shoulder screws 48 which are fastened to mounting holes 34 from behind the rear part 50.

Side heater 33 comprises heater body 57 which is equipped with heater element 54 and temperature sensor 56. To prevent the heating of rear part 50, thermal insulation material 58 is attached to the back of body 57 underneath jacket 59. To prevent the loss of heat, thermal insulation material 53 is attached under jacket 51 at the flanks and on top of body 57.

FIG. 19 shows bookbinding machine 100. The operation of bookbinding machine 100 is started by putting glue cartridge 1, 20 into place in gluing unit 26 and by closing protective cover 115. Plug 116 in cable 107 is connected to the mains. After that, current switch 106 in control panel 108 is turned from the position OFF to the position ON. The current flowing from cable 107 heats up the resistors in the heating units (lower heaters 31 and side heater 33) and melts the glue in glue tank 1.

Bookbinding machine 100 is equipped with operating handle 114. The operating principle of operating handle 114 and the operating mechanism of the bookbinding machine connected to it have been presented in more detail in the patent EP 1 478 519 B1.

The mode of operation of bookbinding machine 100 is shown in more detail in the video http://fastbind.com/images/stories/videos/elite_soft_cover. wmv

Book cover 121 is placed into bookbinding machine 100 and bundle 120 of sheets to be bound on top of it.

The side edge of bundle 120 is aligned against aligning stop 109. After that, bundle 100 is locked in place by turning operating handle 105, whereby mobile press bar 102 presses bundle 120 against turntable 112. After that, press bar 102 is locked in relation to turntable 112 by continuing to turn operating handle 105, whereby bundle 120 also keeps its position in relation to turntable 112.

After that, operating handle 103 is turned in the direction of arrow b. Due to this, turntable 112 turns to a position in which spine edge 124 of bundle 120 is on the route of the backwards and forwards movable (arrow c) glue cartridge receiving unit 26 and especially of glue spreading roller 7 located there. Glue cartridge receiving unit 26 can be moved together with glue spreading unit 111 along linear guide 113. The movement is preferably carried out using a guiding tool, such as knob 114. The system also comprises a transmission device, for example a tooth chain, which rotates the traction element, preferably in a shape-limiting manner. The transmission device forces traction element 1 to rotate every time receiving unit 26 of glue cartridge 26 is pushed in either direction along linear guide 113.

The rotating traction element rotates the formed part which rotates glue spreading roller 7 as described above, whereby glue spreading roller 7 takes glue out of glue tank 2 and applies it to spine edge 124 of bundle 120. When the traction element is standing still, i.e. glue spreading roller 7 does not rotate, the shape of glue spreading roller 7 prevents glue from escaping from glue tank 2.

In case any glue remaining at the lower edge of glue spreading roller 7 should drip, bookbinding machine 100 is also equipped with drip tray 110 for the glue dripping or possibly leaking from glue spreading roller 7.

When spine edge 124 of bundle 120 is glued, operating handle 103 is turned in the direction of arrow a, whereby turntable 112 and bundle 120 rotate against cover 121. By pressing operating handle 103 further in the direction of arrow a, the mechanism in bookbinding machine 100 presses the edge of cover 121 against bundle bound tight on the edge on the side of spine edge 124 as described in patent 1 478 519 B1.

After that, the finished book is released by turning operating handle 105 and bookbinding machine 100 can be used for binding the next bundle of sheets together and to the cover.

The improvement of bookbinding machine 100 shown in FIG. 19 is based on the fact that the mounting of glue cartridges 1, 20 in system 26 is easier thanks to the self-adjusting or adjustable jaw. The dimensional tolerances of glue cartridges 1, 20 can also be greater. Thanks to the self-adjusting feature or adjustability, it is also easier to avoid the problems possibly caused by the different degree of thermal expansion in different pieces, such as glue cartridge 1, 20 getting blocked in system 26.

Glue cartridge 1, 20 is mounted or can be mounted in glue cartridge receiving unit 26. This enables to change the glue type used on the fly (while the operation is running) or with a short break at the most. Glue cartridge 1, 20 can be exchanged even if bundle 120 to be bound is in place in bookbinding machine 100.

During the spreading of glue, glue spreading roller 7 supplies glue tank 2 with the amount of replacing air corresponding to the amount of glue taken by glue spreading roller 7 from glue tank 2 for spine edge 124 of bundle 120 to be bound, or to the amount of glue that otherwise escapes from glue spreading roller 7, for example by dripping. In this way, no under-pressure is developed in glue tank 2 that would make it more difficult to get the glue out of glue tank 2. The amount of replacing air most advantageously corresponds to the amount of glue that has been transferred to spine edge 124 of bundle 120 and has dripped onto drip tray 110.

Glue cartridge 1, 20 can also be heated in advance until it is warm (for example even up to or almost to processing temperature, or, accordingly, for example to midway between the ambient temperature and the processing temperature of glue, or to any other point between them) at a preheating station connected to bookbinding machine 100 or located outside it. Such a preheating station has most advantageously a heating arrangement corresponding to side heater 33 and/or to lower heaters 31, as well as a receiving unit corresponding to glue cartridge receiving unit 26. Thanks to preheating, glue cartridge 1, 20 is available faster, and the use of bookbinding machine 100 can be continued uninterruptedly. In the method for accelerating the adhesive binding, glue tank 2 of glue cartridge 1, 20 is heated before mounting glue cartridge 1, 20 in bookbinding machine 100.

All parts of glue cartridge 1, 20, except for bearings 8, can be made of aluminum. Shaft 3 and glue spreading roller 7 are most advantageously implemented as an extruded aluminum profile. In this case, the extrusion is implemented on the profile of glue spreading roller 7 and, for shaft surface 3, material is removed from the profile by turning on a lathe (removal of teeth or protrusions, in addition to which shaft 3 is made thinner on the outside part of glue spreading roller 7).

Glue cartridge 1, 20 is removed from bookbinding machine 100 after use. If the part to be removed is hot, the removal can be carried out by means of separate setting device 21.

The invention should not be understood as being limited only to the attached patent claims, but it should be understood to include all their legal equivalents.

Especially the shape and amount of shoulders in glue cartridge receiving unit 26 may vary. The number and execution type of arms 41a, 41b may also vary. The jaw can also be implemented in many different ways.

### REFERENCE NUMBERS USED

1 glue cartridge
2 glue tank
3 shaft
4 platform
5 extension
5b stop face of upper side
6 narrowed part
6b narrowing of upper side
7 glue spreading roller
7a knob
7b cover
8 bearing
9 rotating device
10 screw
11 identification element
12 glue channel
13 thread
14 thread
15 bottom of glue tank
16 mounting plate
17 threaded hole
18 fixing screw
19 raising bush
20 glue cartridge equipped with mounting plate
21 setting device
22 plate
23 fixig screw
24 mounting plate
25 compression nut
26 glue cartridge receiving unit (system)
27 handle
28 locking latch
29 bearing journal
30 locking groove
31 lower heater
32 torque converter
33 side heater
34 mounting hole
35 electric cable
36 spring
37 fixing screw
38 suspension loop
39 guard plate of switch room
40 through hole of mounting tool
41a left arm
41b right arm
42 shoulder
43 fixing screw
44 mounting hole
45 through hole of tool
47 spring
48 shoulder screw
49 mounting hole
50 rear part
51 jacket
52 screw
53 thermal insulation material
54 heating element
55 screw
56 temperature sensor
57 heater body
58 thermal insulation material
59 jacket
60 screw
61, 62, 63 fasteners
64 spring
65 screw
66 mounting hole
67 limit stop
68 release plate
80 casing of glue spreading roller
83 face
84 bevel
85 bevel
86 flank
100 bookbinding machine
102 press bar
103 operating handle
105 operating handle
106 current switch
107 cable
108 control panel
109 aligning stop
110 drip tray
111 glue spreading unit
112 turntable
113 linear guide
114 knob
115 protective cover
116 plug
120 bundle of sheets to be bound
121 book cover
124 spine edge

Modifications and substitutions by one of ordinary skill in the art are considered to be within the scope of the present invention, which is not to be limited except by the allowed claims and their legal equivalents.

1. A system (26) for using an exchangeable glue cartridge (1, 20) comprising:
at least one retaining arrangement (31, 41a, 41b, 42) which forms a self-adjusting or adjustable jaw, in which the platform (4) of a glue cartridge (1, 20), which comprises:
a glue tank (2) as well as a platform (4) connected to it,
a rotatable glue spreading roller (7), connected to the glue tank and arranged directly below the glue tank (2) and designed in such a way that the shape of glue spreading roller (7):
prevents glue from escaping from the glue tank (2) when the glue spreading roller (7) is in place and
takes glue out of the glue tank (2) when the glue spreading roller (7) is rotated, as well as
at least one rotating device (9) for rotating the glue spreading roller (7), available outside the glue cartridge (1),
can be pushed in such a way that the glue spreading roller (7) is downward or remains downward, and which is configured to limit the vertical mobility of the glue cartridge (1, 20) in both directions by limiting the mobility of the platform (4); and
at least one rotatable converter (32) for transmitting the motion to at least one rotating device (9) located in the glue cartridge (1, 20) while the glue cartridge (1, 20) is mounted in place.

2. A system (26) according to claim 1, wherein the jaw comprises at least one shoulder (42) for the shape-limiting vertical limitation of the glue cartridge (1, 20) upward.

3. A system (26) according to claim 1, wherein the jaw comprises at least one resilient or resiliently mounted lower part (31).

4. A system (26) according to claim 3, wherein the lower part (31) can be moved in the direction of the shoulder (42) and/or away from it.

5. A system (26) according to claim 4, wherein the lower part (31) is a heater or contains a heater which is arranged to heat from below the platform (4) of the glue cartridge (1, 20) mounted in place.

6. A system (26) according to claim 1, wherein a) the at least one retaining arrangement (31, 41a, 41b, 42) comprises at least one pair of supporting elements or arms (41a, 41b) between which the glue cartridge (1, 20) can be mounted, and b) the jaw is implemented by means of supporting elements or arms (41a, 41b).

7. A system according to claim 6, wherein a shoulder (42) and/or a lower part (31) is or are a part of the supporting elements or arms (41a, 41b).

8. A system according to claim 6, wherein the mutual dimensioning of the platform (4) and the supporting elements or arms (41a, 41b) is implemented in such a way that at least one narrowed part (6, 6b) remains on one side or on both sides between the platform (4) and the supporting elements or arms (41a, 41b), with a gap remaining between them at the narrowed part/narrowed parts (6, 6b).

9. A system according to one of the claim 6, comprising a spring system (64) for pressing or pulling the glue cartridge (1, 20) horizontally toward the second retaining arrangement (31, 41a, 41b, 42).

10. A system according to one of the claim 1, additionally comprising a half-open half-heater, side heater, half-open surface and/or half-open jacket heater (33) for heating the glue in the glue tank (2) of the glue cartridge (1, 20) mounted in place by means of heat to be conducted through the side walls, surface and/or jacket surface of the glue tank (2).

11. A system according to claim 10, wherein the half-heater, side, surface and/or jacket heater (33) is against the glue tank (2) when the glue cartridge (1, 20) is mounted in place.

12. A system according to claim 1, additionally comprising a glue cartridge (1, 20) mounted in place, with this glue cartridge (1, 20) comprising:
a glue tank (2) as well as a platform (4) connected to it;
a rotatable glue spreading roller (7), connected to the glue tank, which is arranged directly below the glue tank (2) and designed in such a way that the shape of the glue spreading roller (7):
prevents glue from escaping from the glue tank (2) when the glue spreading roller (7) is in place and
takes glue out of the glue tank (2) when the glue spreading roller (7) is rotated; as well as
at least one rotating device (9) for rotating the glue spreading roller (7), available outside the glue cartridge (1, 20) and fitted into the converter (32),
whereby the glue spreading roller (7) can be rotated by means of the converter (32).

13. A system (26) according to claim 12, additionally comprising a fixed or a detachable setting device (21) for removing the glue cartridge (1, 20) from the system (26) or for mounting it in the system (26).

14. The system of claim 12 further including a bookbinding machine (100), wherein a bundle (120) of sheets to be bound to make a book can be placed and by means of which glue can be applied to the spine of the bundle (120) in such a way that the glue can be taken from the exchangeable glue cartridge (1, 20) by means of the system (26).

15. A bookbinding machine (100) according to claim 14, comprising a backwards and forwards movable glue spreading unit (111) which is configured to rotate the glue spreading roller (7) of the exchangeable glue cartridge (1, 20) while the glue spreading unit (111) is moved backwards and forwards, whereby the glue in the glue tank (2) can be applied to the spine of the bundle (120).
